(19) United States
(12) Patent Application Publication
(10) Pub. No.: US 2022/0067635 A1
(43) Pub. Date: Mar. 3, 2022

(54) INVENTORY TRACKING SYSTEMS AND METHODS

(71) Applicant: InVue Security Products Inc., Charlotte, NC (US)

(72) Inventors: Christopher J. Fawcett, Charlotte, NC (US); Jeffrey A. Grant, Charlotte, NC (US)

(21) Appl. No.: 17/414,527

(22) PCT Filed: Dec. 16, 2019
(86) PCT No.: PCT/US19/66571

§ 371 Date: Jun. 16, 2021

Related U.S. Application Data
(60) Provisional application No. 62/780,494, filed on Dec. 17, 2018.

(51) Int. Cl. G06Q 10/08; G08B 13/24; G06K 7/10

(52) U.S. Cl. CPC G06Q 10/083; G06K 7/10366; G08B 13/2402

(57) ABSTRACT

Systems, devices, and methods of tracking merchandise to be stored in a secure enclosure are provided. In one embodiment, an inventory tracking device comprises a secure enclosure, having a monitored space defined by a fixed portion and a movable portion and configured to store one or more items of merchandise in the monitored space. Each item of merchandise has a radio frequency identification (RFID) tag to identify the respective item of merchandise. The movable portion is configured to move between an opened position and a closed position, the opened position allowing items of merchandise to be placed into or removed from the monitored space. The inventory tracking device further comprising an RFID reader configured, in response to the movable portion being moved to the opened position or the closed position, to detect the presence of the one or more items of merchandise within the monitored space of the secure enclosure.

### CROSS REFERENCE TO RELATED APPLICATIONS

This application claims the benefit of and priority to U.S. Provisional Application No. 62/780,494, filed on Dec. 17, 2018, the entire disclosure of which is incorporated herein by reference.

### FIELD OF THE INVENTION

Embodiments of the present invention relate generally to inventory tracking systems and methods for use in retail.

### BACKGROUND OF THE INVENTION

Retailers often display samples of merchandise items to allow customers to see the items that they may wish to buy. Given the opportunity to observe and touch the items of merchandise, a customer may be more likely to make a purchase. Small items of merchandise, such as electronic devices, may be stored within security packaging, attached to a display stand or other security device, or placed in a display cabinet, while still allowing potential customers to see and handle the items. The small size and relative expense of some items, however, makes these items an attractive target for shoplifters.

Some items of merchandise may be securely displayed in a display case or display cabinet. In order for a potential customer to get a closer look at the merchandise, an owner or an employee at the store may use a key to open a lock on the case to allow users to sample the item for potential purchase.

Secured items may be stored in displayed cases or in other secured cabinets that may be locked and unlocked at different times. When unlocked, the doors or drawers of these cabinets can be opened to allow items to be removed. Also, additional merchandise can be added to the display cases when items are sold or when new items are to be displayed.

In addition to security measures that may be taken to deter theft, it is also useful for merchants to keep track of inventory to determine how many of each item is available for purchase in each display cabinet in a store and in different store locations. Inventory information can be used to determine whether certain items need to be restocked. Also, when online orders are received, it is beneficial that the merchant is aware of accurate inventory information that can be conveyed to the customer. Otherwise, the merchant may miss out on potential sales or the merchant may give inaccurate information to a customer which may lead to a negative purchasing experience.

### BRIEF SUMMARY

Embodiments of the present invention are directed towards inventory tracking systems, devices, and methods. In one embodiment, an inventory tracking device includes a secure enclosure having a monitored space defined by a fixed portion and a movable portion, wherein the secure enclosure is configured to store one or more items of merchandise in the monitored space, and each item of merchandise has a radio frequency identification (RFID) tag to identify the respective item of merchandise. The movable portion is configured to move between an opened position and a closed position, wherein the opened position allows items of merchandise to be placed into or removed from the monitored space. The inventory tracking device also includes an RFID reader configured, in response to the movable portion being moved to the opened position or the closed position, to detect the presence of the one or more items of merchandise within the monitored space of the secure enclosure.

In another embodiment, a method of tracking inventory is provided and includes the steps of determining when a moveable portion of a secure enclosure has been opened and determining when the moveable portion has been closed. When it is determined that the moveable portion has been opened or closed, the method further includes utilizing a radio frequency identification (RFID) reader to perform an RFID scan of one or more items of merchandise within the secure enclosure to determine inventory information.

In another embodiment, an inventory tracking system is provided and includes a backend device and a plurality of secure enclosures. Each secure enclosure includes a monitored space configured to store one or more items of merchandise, wherein each item of merchandise has a radio frequency identification (RFID) tag to identify the respective item of merchandise. In addition, each secure enclosure further comprises a moveable portion configured to move between an opened position and a closed position, wherein the opened position allows the one or more items of merchandise to be placed into or removed from the monitored space. Each secure enclosure further comprises a trigger device configured to provide a trigger signal to indicate when the respective moveable portion has moved from the opened position to the closed position. Each secure enclosure further comprises an RFID reader configured, in response to the trigger signal, to detect the presence of the one or more items of merchandise within the monitored space of the respective secure enclosure, and each secure enclosure further comprises a communication device configured to send inventory information to the backend device.

In one embodiment, an inventory tracking device includes a secure enclosure having a monitored space defined by a fixed portion and a movable portion, wherein the secure enclosure is configured to store one or more items of merchandise in the monitored space, and each item of merchandise has a radio frequency identification (RFID) tag to identify the respective item of merchandise. The inventory tracking device further includes an electronic lock configured to lock the movable portion to the fixed portion and to be unlocked with an electronic key. The movable portion is configured to move between an opened position and a closed position, wherein the opened position allows items of merchandise to be placed into or removed from the monitored space. Moreover, the inventory tracking device includes an RFID reader configured, in response to the electronic lock being unlocked or locked, to detect the presence of the one or more items of merchandise within the monitored space of the secure enclosure.

### BRIEF DESCRIPTION OF THE DRAWINGS

FIG. 1A is a perspective view of a display cabinet according to one embodiment of the present invention.

FIG. 1B is a perspective view of an electronic key according to one embodiment of the present invention.

FIG. 2 is a perspective view of a cabinet according to one embodiment of the present invention.

FIG. 3 is a schematic of a sensor circuit according to one embodiment of the present invention.

FIG. 4 is a block diagram illustrating an embodiment of an inventory tracking system.

FIG. 5 is a block diagram illustrating an embodiment of the backend device.

FIG. 6 is a flow diagram illustrating a method of monitoring inventory of items according to one embodiment of the present invention.

### DETAILED DESCRIPTION OF EMBODIMENTS OF THE INVENTION

Referring now to the accompanying drawing figures wherein like reference numerals denote like elements throughout the various views, one or more embodiments of an inventory tracking system are shown. In the embodiments shown and described herein, the inventory tracking system may be included with security systems for preventing theft.

Although the following discussion relates to a system for use in a retail store, it is understood that the system is also suitable for other industries, such as warehouses, hospitals, restaurants, etc. In some embodiments, the merchandise security devices and the electronic keys may be similar to those disclosed in U.S. application Ser. No. 13/222,225 (U.S. Publ. No. 2012/0047972), filed on Aug. 31, 2011, entitled “Electronic Key for Merchandise Security Device” and U.S. application Ser. No. 15/540,403 (U.S. Pat. No. 10,127,745), filed Dec. 21, 2015, entitled “Merchandise Display Security Systems and Methods,” the entire disclosures of which are incorporated herein by reference in their entirety.

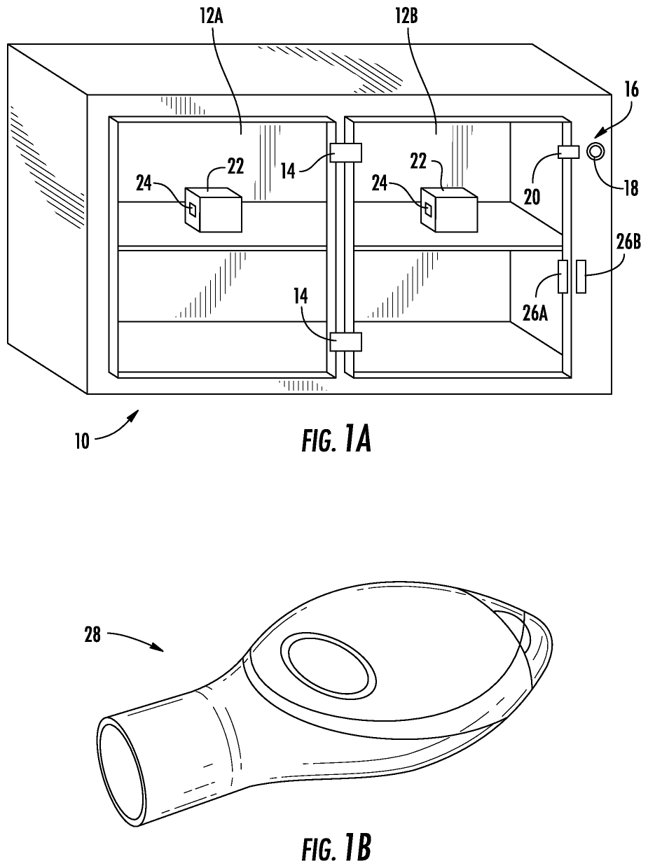

FIG. 1A is a diagram illustrating an embodiment of a display cabinet 10, or secure enclosure. In this embodiment, the display cabinet 10 includes glass doors 12A and 12B, where door 12B is attached to the door 12A or to the frame of the cabinet 10 by one or more hinges 14. In other embodiments, the doors 12A, 12B may be configured to slide with respect to each other along tracks.

To lock the display cabinet 10, a security device 16, or lock, is installed, which may include at least an electronic key port 18 and a latch 20. For example, when an electronic key 28 (see FIG. 1B) is inserted into the port 18 or placed within range of the port 18 for making an electrical or electromagnetic connection, the latch 20 is configured to unlock the security device 16 to allow the door 12B to be opened.

FIG. 1B is a diagram illustrating an embodiment of the electronic key 28, which may be configured to unlock or disarm the security device 16. The electronic key 28 may include a power source configured to transfer power to the security device 16. The system may further comprise a programming station (not shown) that is operable for programming the electronic key 28 with a security code, which may also be referred to herein as a Security Disarm Code (SDC). In addition to the programming station, the system may further comprise an optional charging station that is operable for initially charging and/or subsequently recharging the power source disposed within the electronic key 28. For example, the key 28 and merchandise security device 16 may each be programmed with the same SDC into a respective permanent memory. The key 28 may be provisioned with a single-use (e.g., non-rechargeable) power source, such as a conventional or extended-life battery, or alternatively, the key may be provisioned with a multiple-use (e.g., rechargeable) power source, such as a conventional capacitor or rechargeable battery. In either instance, the power source may be permanent, semi-permanent (e.g., replaceable), or rechargeable, as desired. In the latter instance, charging station is provided to initially charge and/or to subsequently recharge the power source provided within the key 28. Furthermore, key 28 and/or security device 16 may be provided with only a transient memory, such that the SDC must be programmed (or reprogrammed) at predetermined time intervals. In this instance, programming station is provided to initially program and/or to subsequently reprogram the SDC into the key 28. As will be described, key 28 may be operable to initially program and/or to subsequently reprogram the security device 16 with the SDC. Key 28 is then further operable to operate the security device 16 by transferring power and/or data to the device.

In one embodiment, the key 28 may be configured to utilize a power transfer function to transfer power to the security device 16. The key 28 transfers power to the port 18 to thereby operate a mechanical and/or electronic lock mechanism associated with the latch 20. Power and data are transferred from the key 28 to the port 18 for authorizing the operation of the security device 16. In some embodiments, the key 28 and security device 16, or lock, may be configured to communicate using infrared (IR) technology for communicating data signals between each other. IR signals may be used for initiating the unlocking of the latch 20 and/or for communicating inventory scanning data from the port 18 to the key 28.

An available feature of the merchandise security system according to one embodiment is that the electronic key 28 may include a time-out function. More particularly, the ability of the key 28 to transfer data and/or power to the security device 16 may be deactivated after a predetermined time period. By way of example, the electronic key 28 may be deactivated after about six to about twenty-four hours from the time the key 28 was programmed or last refreshed. In this manner, an authorized sales associate typically must program or refresh the key 28 assigned to him or her at the beginning of each work shift. Furthermore, the charging/authorization station may be configured to deactivate the electronic key 28 when the key is positioned within or otherwise engaged with a charging port. In this manner, the charging station can be made available to an authorized sales associate. In one embodiment, the electronic key 28 may be authorized upon the sales associate inputting an authorized code to release the key for use. For instance, the sales associate may input a code on a keypad in communication with the charging station. Upon inputting the correct code, the charging station may indicate which key 28 is authorized for use by the sales associate (e.g., via an audible and/or a visible indicator). In some cases, the time-out period may be predetermined or customized by a user. For example, a manager of a retail store may input a particular time period for one or more of the electronic keys 28. Those electronic keys 28 that are “active” may be monitored via communication within the cloud-based network. In other embodiments, the electronic key 28 may be timed out or otherwise disabled in response to an event. For instance, the electronic key 28 may be disabled in response to the key being misplaced or stolen, or keys being brought into a retail store that are not authorized for use. Such disabling may occur via a command sent to the electronic key 28 via a cloud network.

In some embodiments, the merchandise security device 16 is a “passive” device. As used herein, the term passive is intended to mean that the security device 16 does not have an internal power source sufficient to lock and/or unlock a mechanical lock mechanism. Significant cost savings are obtained by a retailer when the merchandise security device 16 is passive since the expense of an internal power source is confined to the key 28, and one such key is able to operate multiple security devices. If desired, the merchandise security device 16 may also be provided with a temporary power source (e.g., capacitor or limited-life battery) having sufficient power to activate an alarm, for example a piezoelectric audible alarm, that is actuated by a sensor, for example a contact, proximity or limit switch, in response to a security breach. The temporary power source may also be sufficient to communicate data, for example a SDC, from the merchandise security device 16 to the key 28 to authenticate the security device and thereby authorize the key to provide power to the security device.

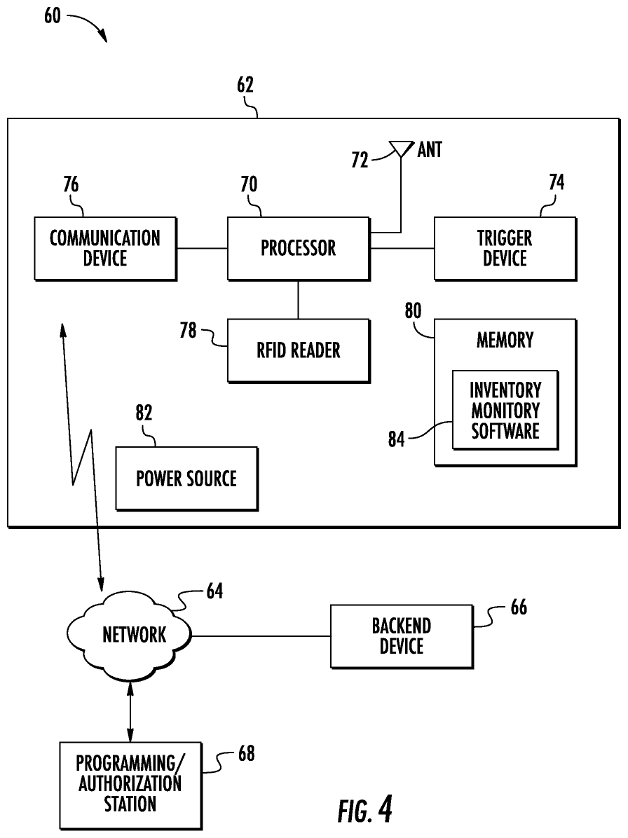

In some embodiments, the merchandise security device 16 further comprises a logic control circuit, similar to the logic control circuit disposed within the key 28, adapted to perform a handshake communication protocol with the logic control circuit of the key in essentially the same manner as that between the programming/authorization station 68 (see FIG. 4) and the key 28. In essence, the logic control circuit of the key 28 and the logic control circuit of the merchandise security device 16 communicate with each other to determine whether the merchandise security device 16 is an authorized device that does not have a security code, or is a device having a matching SDC. In the event the handshake communication protocol fails (e.g., the device is not authorized or the device has a non-matching SDC), the key 28 will not program the device with the SDC, and consequently, the merchandise security device will not operate. If the merchandise security device 16 was previously programmed with a different SDC, the device will no longer communicate with the key 28. In the event the handshake communication protocol is successful, the key 28 permits the SDC stored in the key to be transmitted to the merchandise security device 16 to program the device with the SDC. As will be readily apparent to those skilled in the art, the SDC may be transmitted from the key 28 to the merchandise security device 16 by any suitable means, including without limitation, via radiofrequency, one or more electrical contacts, electromechanical, electromagnetic or magnetic conductors, as desired. Furthermore, the SDC may be transmitted by inductive transfer of data from the electronic key 28 to the merchandise security device 16. Moreover, in other cases the electronic key 28 may simply provide the SDC to the merchandise security device 16 without first initiating any handshake communication protocol.

In one embodiment, when the handshake communication protocol is successful and the merchandise security device 16 is an authorized device having the matching SDC, the merchandise security device may be armed or disarmed, such as where the security device includes an alarm circuit. In other embodiments, the merchandise security device 16 may be armed or disarmed when the SDC codes match. In some embodiments, when the handshake communication protocol is successful and the SDC codes match, the logic control circuit of the key 28 causes an internal power source of the key to transfer electrical power to the device 16 to operate a mechanical lock mechanism. In other embodiments, the merchandise security device 16 may be locked or unlocked when the SDC codes match and power is transferred to the merchandise security device. It is understood that various information and codes may be exchanged in order to perform the desired function, such as arming, disarming, locking, or unlocking the merchandise security device 16. For example, the data exchanged may include a serial number of the merchandise security device alone and/or an SDC.

The display cabinet 10 may include any suitable type of locking mechanism for locking the doors 12A, 12B. It should be understood that other configurations of cabinets, doors, and/or locks may be implemented in addition to the cabinet 10 shown in FIG. 1. Thus, embodiments of the present invention may be suitable for any secure enclosure having a fixed portion (e.g., cabinet) and a movable portion (e.g., door) that define a monitored space, as described in greater detail below.

When one or more doors 12A, 12B are unlocked, the doors can then be opened, allowing a person to remove an item 22 of merchandise from the cabinet 10. The cabinet 10 includes a secured area or space within the frame of the cabinet 10, which is only accessible when an authorized key unlocks the lock 16 and the door 12 is opened. In some embodiments, each of the items 22 of merchandise may be packaged using suitable packaging and may include a radio frequency identification (RFID) tag 24 on the outside of the packaging, on the inside of the packaging, embedded in the packaging, or even on the item itself.

According to some embodiments, the cabinet 10 may include a sensor for detecting whether the door 12B is opened or closed. For example, the sensor may include a first terminal 26A connected to the door 12B and a second terminal 26B connected to the cabinet 10 in a location adjacent to or in contact with the first terminal 26A when the door 12B is in the closed position. Thus, the sensor can detect whether the door 12B is opened or closed based on the whether an electrical coupling is made between the terminal 26A, 26B, either directly or indirectly. The terminals 26A, 26B may be configured as a switch that opens (i.e., open circuit condition) when the door 12B is open and that closes (i.e., closed circuit condition) when the door 12B is closed. The terminals 26A, 26B may use electrical contacts that make physical contact when the door 12B is closed, or alternatively may include magnetic or capacitive elements that may sense when the terminals 26A, 26B are in range of each other to allow the sensor to detect the opened or closed condition. In other embodiments, the sensor may be a mechanical plunger or pressure-type switch.

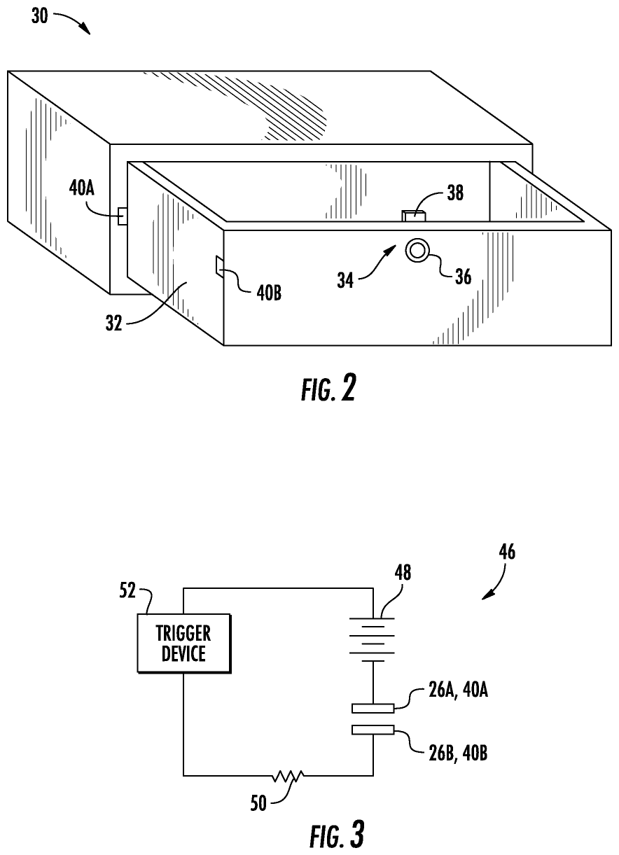

FIG. 2 is a diagram illustrating an embodiment of a cabinet 30 having a drawer 32 that is slidable with respect to the cabinet 30. The cabinet 30 may also be configured for securely storing merchandise. The cabinet 30 includes a lock 34 having a receptacle 36 and a latch 38, which may be similar to the receptacle 18 and latch 20 shown in FIG. 1. By inserting a corresponding key (e.g., electronic key) in the receptacle 36 or placing the key in proximity to the receptacle 36, the latch 38 of the lock 34 is configured to unlock to allow the drawer 32 to be opened. The latch 38 may be configured to automatically lock when the drawer 32 is closed again.

Furthermore, the cabinet 30, like the cabinet 10 of FIG. 1, further includes a sensor for detecting whether the drawer 32 is in the closed position or opened position. In the opened position, merchandise can be supplied to the drawer 32 or removed from the drawer 32. In the closed position, the merchandise of course cannot be removed. Associated with the sensor are terminals 40A and 40B. Terminal 40A is positioned on the cabinet 30 itself and remains stationary. However, terminal 40B is connected to the drawer 32 and is moveable with respect to the stationary terminal 40A. When the drawer 32 is in the closed position, the terminals 40A, 40B will be positioned in contact with each other or within close proximity to allow the sensor to detect that the drawer 32 is indeed closed. Otherwise, when the drawer 32 is open, the terminals 40A, 40B will not be positioned within range of each other, which will be sensed by the sensor as an open condition.

FIG. 3 is a schematic diagram illustrating an embodiment of a circuit 46 of the sensor mentioned with respect to FIGS. 1 and 2. For example, the circuit 46 may include the pair of terminals 26A, 26B shown in FIG. 1 for detecting whether the door 12B is in a closed position or may include the pair of terminals 40A, 40B shown in FIG. 2 for detecting whether the drawer 32 is in a closed position.

The circuit 46 of FIG. 3 may include a power source 48, such as one or more batteries. The circuit 46 may further include a resistor 50 and a trigger device 52. The trigger device 52 may be configured to supply a trigger signal, as explained in more detail below, if the terminals 26A/40A and 26B/40B contact each other (e.g., in a short circuit/open circuit arrangement) or are within an acceptable range of each other (e.g., in a magnetic or capacitance arrangement). The trigger signal supplied by the trigger device 52 may be high (on) when the terminals are in the closed position and may be low (off) when the terminals are in the opened position. Thus, a receiving device (e.g., inventory tracking device 62) that receives the trigger signal from the trigger device 52 will know whether the door 12B or drawer 32 is opened or closed.

FIG. 4 is a block diagram illustrating an embodiment of an inventory tracking system 60. In this embodiment, the inventory tracking system 60 includes one or more inventory tracking devices 62, a cloud network 64, a backend device 66, and one or more programming/authorization stations 68. The backend device 66 may be configured to monitor the activities of one or a plurality of inventory tracking devices 62, whereby each inventory tracking device 62 is associated with one cabinet (e.g., cabinet 10 of FIG. 1, cabinet 30 of FIG. 2, or other cabinet). Also, a first set of inventory tracking devices 62 may be arranged within one store, a second set of inventory tracking devices 62 may be arranged within another store, and so on. Thus, the backend device 66 can monitor activity involved with multiple cabinets within any number of stores. Furthermore, the programming/authorization station 68 may be placed in a retail store to program and charge the electronic keys 28, which may be used to transfer power and data. Data which is communicated to the electronic keys 28 from the inventory tracking device 62 and security devices 16 can then be forwarded to the backend device 66 via the network 64.

The inventory tracking device 62 may be included within the respective cabinet for tracking the inventory that is being stored within that cabinet. The inventory tracking device 62 may be positioned within the cabinets, for example, so as not to interfere with the displayed merchandise (e.g., merchandise 22 shown in FIG. 1). In some cases, the inventory tracking device 62 may be integrated in an electronic lock.

In the illustrated embodiment, the inventory tracking device 62 includes a processor 70 (or multiple processing devices), one or more antennas 72, a trigger device 74 (e.g., trigger device 52 shown in FIG. 3), communication device 76, an RFID reader 78 (or multiple RFID readers), memory 80, and a power source 82. The memory 80 may be configured with volatile and/or non-volatile memory modules and may include non-transitory computer-readable media. For instance, the memory 80 may include inventory monitoring software 84 for enabling the processor 70 to perform logic functions related to monitoring the inventory stored in a secured display cabinet, such as cabinets 10, 30, or other suitable cabinets within which the inventory tracking device 62 is stored.

In operation, the processor 70 is configured to run the inventory monitoring software 84 stored in memory 80 to monitor the inventory within the respective cabinet. The processor 70 receives a trigger signal from the trigger device 74 indicating when the cabinet experiences a transition from a closed condition to an open condition and also when the cabinet experiences a transition from the open condition to the closed condition. After the doors or drawers of the cabinet have been closed (having previously been in the open condition), the inventory tracking device 62 is configured to detect what items are currently present within the cabinet.

To detect what items are present in the cabinet, the processor 70 instructs the RFID reader 78 to perform a scanning or interrogation function. The RFID reader 78 may be configured to use the antennas 72 or other RF antenna for sending an interrogation signal to any RFID tags (e.g., RFID tags 24 shown in FIG. 1) within range (e.g., within the secured space in the interior of the cabinet). For example, the RF range depends on the size of the cabinet, the number of RFID readers 78 placed in the cabinet, and the orientation and/or positioning of the RFID readers 78 within the cabinet. According to one embodiment, the antennas 72 may be oriented orthogonally with respect to each other or arranged at any suitable angles and directions to allow the antennas 72 to adequately scan all the spaces within the cabinet. In some embodiments, the inside walls of the cabinet may include signal blocking material designed to ensure that RF signals are sufficient to power only the RFID tags of merchandise within the cabinet itself and not RFID tags on merchandise outside the cabinet.

In response to the interrogation signal, the RFID tag 24 on any merchandise inside the cabinet wirelessly provides an identification signal identifying the merchandise present in the cabinet. The RFID reader 78 reads the identification signals from each item of merchandise and provides this information to the processor 70. The scanning, reading, or interrogating of the RFID tags 24 results in the generation of various data regarding the merchandise, such as timestamps (e.g., times and dates) when the cabinet was unlocked, locked, armed, disarmed, opened, closed, etc. Other data resulting from the interrogation includes identification of the merchandise present within the secure enclosure, wherein the identification information may include, for example, serial numbers, product numbers, etc. More data may further include information about the cabinet, such as, for example, a cabinet number within a store, the location of the cabinet within the store, the store number, the location of the store, etc. The resulting information may be stored in the memory 80.

The processor 70 can use the received data to obtain information about each of the items in the cabinet. The communication device 76 may be configured to communicate information to the backend device 66 via the network 64. The communication device 76 may utilize the antenna 72 for providing Wi-Fi signals to a Wi-Fi router in communication with the network 64. Alternatively, the information may be provided to the electronic key 28 used for opening the lock 16, 34, whereby the electronic key 28 may be configured to store the information and then communicate the information to the backend device 66 through the programming/authorization station 68. In another embodiment, the communication device 76 may be a cellular module for sending information through a cellular network 64 to the backend device 66.

The processor 70 may be configured to inform the RFID reader 78 when the cabinet is closed and/or when the cabinet is locked. At the time that the cabinet is closed or locked or after a short delay from the closing or locking of the cabinet, the processor 70 and RFID reader 78 may be configured to enter a sleep mode in order to conserve power.

The processor 70 and RFID reader 78 may also be configured to wake up according to pre-programmed times, even when the cabinet remains closed and locked. The inventory tracking device 62 may be configured to wake up and then conduct an inventory scanning process to confirm the latest status of the presence of merchandise inside the cabinet. This supplemental scanning process may be conducted in the event that the items have been removed without the inventory tracking device 62 detecting that the cabinet has been opened or unlocked. For instance, if a thief breaks the glass of the cabinet, the opening or locking may not necessarily be detected. Thus, the supplemental scanning may show that merchandise has been removed with respect to previous scanning processes. The inventory tracking device 62 may further be configured to perform a scanning process in response to an external request, such as a request from the backend device 66. This remote request may be performed according to pre-scheduled scanning times or in response to a specific request by a user of the backend device 66.

In response to receiving a trigger signal, the inventory tracking device 62 may act in a single-read manner or in a multiple-read manner. In a single-read manner, the RFID reader 78 is configured to scan the interior of the secure cabinet only once to determine the identity of the merchandise therein. In a multiple-read manner, the RFID reader 78 may be configured to initiate the sending of an interrogation signal and receive response signals from the RFID tags 24 in multiple reads. The multiple reads may be continuous or periodic. In the multiple-read scenario, the RFID reader 78 may scan the interior multiple times throughout the time that the door of the secured cabinet is open. The advantage of multiple reads is that the inventory tracking device 62 may be configured to not only determine what merchandise is inside the cabinet when the door is first opened, but also determine when items of merchandise are placed into the cabinet and when items are removed from the cabinet as well as the identity of each item of merchandise.

The power source 82 may be configured to power the components of the inventory tracking device 62. In some embodiments, the power source 82 may include one or more batteries, such as alkaline batteries or rechargeable batteries. According to other embodiments, the power source 82 may include an adapter for receiving power from an electrical outlet and providing DC power to the components of the inventory tracking device 62.

As mentioned above, each cabinet in a store or within multiple stores is configured to include the inventory tracking device 62. Thus, the backend device 66 is configured to receive information from multiple cabinets. The backend device 66 may utilize various software to track inventory within a cabinet, within a store, and/or within a group of stores. The tracked inventory information may include when each cabinet was opened and closed, when each cabinet was locked or unlocked, the identity of the person or people using the electronic keys (in situations where the user must “check out” identification information in order to use the electronic key) to unlock the cabinets, and the items of merchandise stored in each cabinet. From this inventory information, the backend device 66 can monitor or track the location of items of merchandise throughout the sales process, from a time when an item is first put on display in a secured cabinet to a time when the item is sold.

In a particular embodiment, the logic control circuit of the programming/authorization station 68 performs an electronic exchange of data with a logic control circuit of the key 28, commonly referred to as a “handshake communication protocol.” The handshake communication protocol determines whether the key 28 is an authorized key that has not been programmed previously (e.g., a “new” key), or is an authorized key that is being presented to the programming/authorization station 68 a subsequent time to refresh the SDC. In the event that the handshake communication protocol fails, the programming station 68 will not provide the SDC to the unauthorized device attempting to obtain the SDC. When the handshake communication protocol succeeds, programming station 68 permits the SDC to be transmitted by the key 28. As will be readily apparent to those skilled in the art, the SDC may be transmitted from the programming station 68 to the key 28 by any suitable means, including without limitation, wireless, electrical contacts or electromechanical, electromagnetic or magnetic conductors, as desired. Moreover, in other cases the programming station 68 may simply provide the SDC to the electronic key 28 without first initiating any handshake communication protocol.

In one embodiment, the electronic key 28 is configured to obtain data from a merchandise security device 16 (e.g., a security fixture). For example, the merchandise security device 16 may store various data regarding past communication with a previous electronic key 28 (e.g., key identification, time of communication, etc.), and when a subsequent electronic key communicates with the same merchandise security device, the data is transferred to the electronic key. Thus, the merchandise security device 16 may include a memory for storing such data. In some cases, the merchandise security device 16 includes a power source for receiving and storing the data, while in other cases, the power provided by the electronic key 28 is used for allowing the merchandise security device to store the data. The electronic key 28 may then communicate the data for collection and review, such as at a remote location (e.g., the backend device 66). In some instances, communication between the electronic key 28 and the programming/authorization station 68 may allow data to be pulled from the electronic key and communicated, such as to a remote location or device. In other cases, the electronic key 28 may be configured to obtain data from merchandise security devices 16 (e.g., a security display), such as an identification of the merchandise security device, the type of item of merchandise on display, an identification of the item of merchandise, and/or the system health of the security device and/or the item of merchandise. The electronic key 28 may store the data and provide the data to a remote location or device upon communication with the programming/authorization station 68. As such, the electronic keys 28 may be a useful resource for obtaining various types of data from the merchandise security devices 16 without the need for wired connections or complex wireless networks or systems.

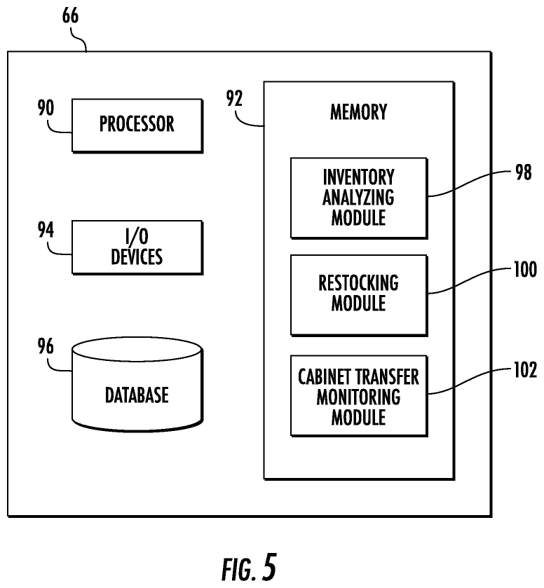

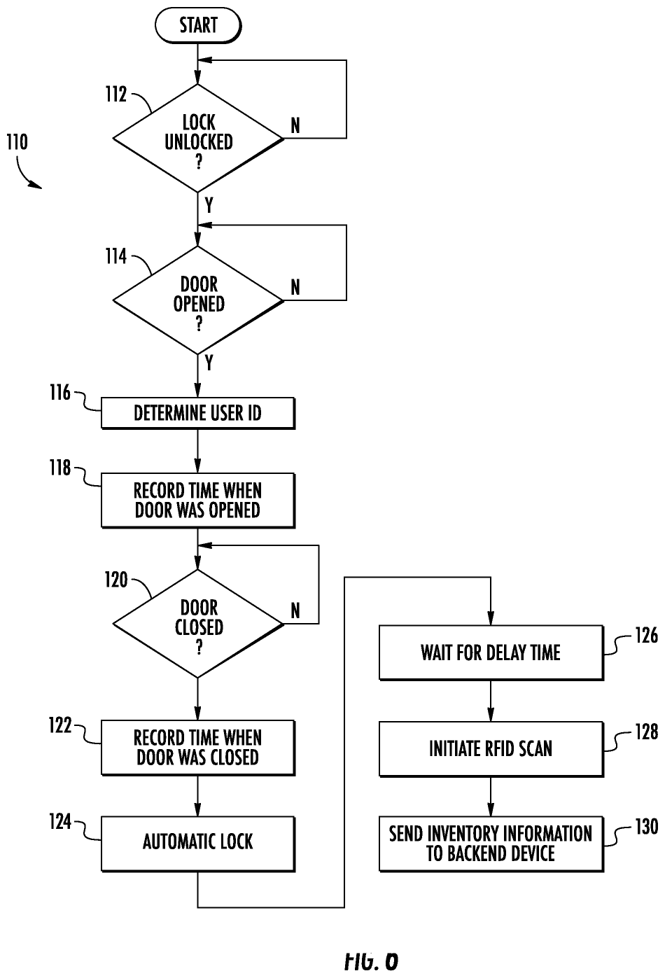

FIG. 5 is a block diagram illustrating an embodiment of the backend device 66 shown in FIG. 4. In this embodiment, the backend device 66 includes one or more processors 90, a memory 92, input/output devices 94, and a database 96. The memory 92 may store software programs for enabling the processor 90 to execute various inventory tracking procedures using the inventory information described above. For example, the memory 92 may include an inventory analyzing module 98, a restocking module 100, a cabinet transfer monitoring module 102, among other software for tracking inventory. In some implementations, the three software modules 98, 100, 102 may be included in a single program.

The inventory analyzing module 98 includes logic instructions to enable the processor 90 to perform an analysis of the inventory of items of merchandise with respect to sales records. For example, the inventory analyzing module 98 may be configured to compare items of merchandise that were present within a cabinet at one time and were then removed at a later time. This information can be compared with the inventory lists detected in other nearby cabinets to determine if the items have subsequently been placed in a different cabinet. If it is determined that an item has not been placed in another cabinet, another comparison can be made with sales records to determine if the item has been sold. From this analysis, the inventory analyzing module 98 can determine if an item is missing. A missing item may be an indication that the item has been left out of a secured cabinet, that the item has been given to a person who has not paid for the item, or that the item has been stolen. An output can be provided via an output device 94 to inform a security person when one or more items are missing so that appropriate action can be taken to recover the items and return them to the secured spaces.

The restocking module 100 is configured to count the number of certain types of items that are stored within a cabinet and compare this number with a predetermined quantity that the merchant may wish to have displayed or stored in inventory at any time. For example, if the merchant determines, based on sales records, that it would be desirable to have between four and eight of one type of product on display or in inventory, then, if the product has been sold such that the number on hand drops below four, then the restocking module 100 may be configured to instruct that more inventory of the product be placed into the display cabinet. The restocking module 100 may use shipping information, if necessary, to request that a certain number of items are shipped to a specific retail store or that items in a stockroom or storage drawer/locker at the store are moved into the secured display cabinet.

The cabinet transfer monitoring module 102 may be configured to analyze the contents of several secured cabinets within a retail store. In this way, the cabinet transfer monitoring module 102 can determine that items that are removed from one cabinet are either sold or transferred into another secured cabinet.

Also, an online-ordering, local pick-up arrangement is described herein. The online-ordering, local pick-up system is configured such that a customer can go online to order an item and then go to a particular store location to pick up the item. According to some systems already in place today, a retailer may underestimate the number of products that are actually in stock at a certain store. For example, the store may not allow an online order to be made if there are fewer than a certain number of items (e.g., four items) known to be in stock. However, with the RFID tracking mentioned in the present disclosure, it is possible to determine how many of each item is currently within secured cabinets.

An advantage of the present disclosure in some embodiments, therefore, is that an accurate accounting of the inventory will be known based on the actual presence of items in the secured spaces, and not necessarily based merely on sales numbers and shipping data. Furthermore, the present system avoids the situation where a customer orders an item online only to find that the item is not in stock at the store. It also avoids the need to have extra inventory on hand to cover any discrepancies in the inventory data when that data is not based on the actual RFID readings as described herein.

According to one implementation of the present system, an online order may be received for pick-up at a store where the item is known to exist. When the order is complete, an employee at that store location can unlock and open a first secure cabinet where the item is originally stored and then transfer that item to a personal pick-up locker (e.g., at the front of the store) where the customer can pick up the item. The system can track which employee unlocked the cabinet and detect that the item has been removed from the cabinet. This detection can be made as mentioned above, whereby the RFID reader 78 scans the secured space of the cabinet after the cabinet has been closed and locked. Then, when a specific locker also having an inventory tracking device 62 is opened and the item is placed in this secured locker, the inventory tracking device 62 can detect that the item has been placed in the respective locker and is ready for pick-up. Also, a notification can be provided to the customer (e.g., via text message or automated phone call) to inform the customer that their item is stored in a specific locker in a specific store.

Thus, the inventory of items within a number of secured cabinets in a store can be monitored remotely by the backend device 66. The database 96 may be configured to store timestamps (e.g., the times and dates) when each cabinet has been opened, when they are closed, the employees who used their secure keys to open the cabinets, items that were added to or removed from the cabinets, and records of items that have sold. Therefore, the backend device 66 can keep track of the location of items, the transfer of items from one cabinet to another, when the cabinets have been restocked, etc.

FIG. 6 is a flow diagram illustrating a method 110 of monitoring the inventory of items having traceable tags attached to the items. According to the illustrated embodiment, the method 110 includes a step of determining whether a cabinet having a secured space has been unlocked, as indicated in decision diamond 112. If the cabinet remains locked, the method 110 loops back to decision diamond 112. When it is determined that the cabinet has been unlocked, the method 110 proceeds to decision diamond 114, where it is determined whether or not the door (or drawer) of the cabinet has been opened such that items of merchandise can be removed. If the door is not opened, the method 110 loops back to decision diamond 114 until the door is opened, at which point, the method 110 proceeds to block 116.

According to some embodiments, step 112 may be omitted in a case where the cabinet does not include a lock. Thus, the method 110 may simply respond to a detection of a door being opened. In other embodiments, step 114 may be omitted, whereby the method 110 may respond to a detection of a lock or other security device being unlocked or disarmed and does not necessary respond to the condition of the door being opened or closed.

When the door (or drawer) is opened (and/or unlocked), the identification of the user who has opened the door is determined, as indicated in block 116, such as by using identification information associated with the electronic key used to unlock the lock. Block 118 includes the step of recording a time when the door was opened. The method 110 further includes determining whether the door has subsequently been closed, as indicated in decision diamond 120. If the door remains open, the method 110 loops back to step 120 until the door is closed. When it is closed, the method 110 proceeds to block 122. As suggested above, the detection of the closing of the door may instead include a detection of the locking or arming of a lock or other security device. Subsequent steps of the method 110 may be altered, according to these alternative embodiments, to respond to the locking/arming of a lock instead of the detection of a door being closed.

In block 122, the method 110 includes the step of recording the time when the door was closed. At this time, an amount of time can be determined from the point when the door was opened to the point when it was closed. Block 124 indicates that the cabinet lock may include an automatic locking feature that locks the lock after the door has been closed. In other embodiments, the locking step of block 124 may be replaced with a step of locking that may be initiated by the user.

Method 110 may further include the step of waiting a certain amount of time, as indicated in block 126. The delay time, for example, may be about three seconds. This delay gives the user an opportunity to open up the cabinet again, if necessary, to add or remove merchandise. After the delay, the method 110 includes a step of initiating an RFID scan process, as indicated in block 128. The RFID scan includes sending an instruction to the RFID readers 78 of the cabinet to provide an interrogation action to detect what items are present within the cabinet. As mentioned above, each item will include a unique RFID tag to distinguish each item from other items. The information regarding the RFID scan can be sent to the backend device, as indicated in block 130, to inform the backend device of the items that are present within the cabinet, the time and date when the door was opened and closed, the employee who opened the door, etc.

Therefore, according to one embodiment, an inventory tracking device (e.g., inventory tracking device 62 shown in FIG. 4) may comprise a cabinet 10, 30 having a monitored space, where the cabinet is configured to store one or more items 22 of merchandise in the monitored space. Each item of merchandise may have a radio frequency identification (RFID) tag 24 to identify the respective item of merchandise. The inventory tracking device further comprises a door associated with the cabinet, where the door is configured to move between an opened position and a closed position, the opened position allowing items of merchandise to be placed into or removed from the monitored space. The inventory tracking device further comprises a trigger device 74 configured to provide a trigger signal to indicate when the door has moved from the opened position to the closed position. Also, the inventory tracking device includes an RFID reader 78, which is configured, in response to the trigger signal, to detect the presence of the one or more items of merchandise within the monitored space of the cabinet.

The inventory tracking device mentioned above may further comprise an electronic lock 16, 34 configured to be unlocked with an electronic key associated with a specific person. The inventory tracking device may further comprise a processor 70 configured to detect when the specific person unlocks/locks the electronic lock and/or opens/closes the door. The inventory tracking device may further comprise a power source 82 configured to power the processor, electronic lock, and trigger device. The power source may include one or more batteries. The trigger device may be incorporated in the electronic lock. Thus, in some embodiments, the trigger device may generate a trigger signal in response to the electronic lock locking or unlocking.

The electronic key may be configured to record times and/or dates when the electronic lock was unlocked and locked, times and/or dates when the door was opened and closed, and items of merchandise that the RFID reader identified as being present within the monitored space. The inventory tracking device may further comprise a communication device 76 configured to send inventory information, where the inventory information includes at least identifying information about the specific person, times and/or dates when the electronic lock was unlocked or locked, times and/or dates when the door was opened or closed, and/or the one or more items of merchandise contained within the cabinet when the trigger signal indicates that the door has moved from the opened position to the closed position. The communication device may be a wireless transmitter configured to wirelessly transmit cellular or Wi-Fi signals to a backend device via a network.

The inventory tracking device described above may further be configured such that the door includes a sliding drawer 32. The trigger device may include an electrical or electromechanical switch configured to detect when the door is in the closed position or opened position. The switch may include a magnetic switch. The RFID reader may be configured to wait for a predetermined amount of time after receiving the trigger signal before detecting the presence of the one or more items of merchandise within the monitored space of the cabinet. The inventory tracking device may further comprise a plurality of RFID readers operating in unison, the plurality of RFID readers configured, in response to the trigger signal, to detect the presence of the one or more items of merchandise within the monitored space of the cabinet.

A method of tracking inventory is also provided in the present disclosure. The method (e.g., method 110) may include steps 114, 120 of determining when a door or drawer of a secured cabinet has been opened and determining when the door or drawer has been closed. When it is determined that the door or drawer has been closed, the method further includes the step 128 of utilizing a radio frequency identification (RFID) reader to perform an RFID scan of the items within the cabinet to determine inventory information.

The method described above may further comprise the step 116 of determining the identity of a user who opened the door or drawer. The method may further include steps 118, 122 of recording the times and/or dates when the door or drawer was opened and when it was closed. Also, the method may include the step 130 of communicating the inventory information to a remote backend device.

Furthermore, an inventory tracking system (e.g., inventory tracking system 60) is provided. The inventory tracking system may include a backend device 66 and a plurality of display cabinets 10, 30. Each display cabinet may comprise a monitored space configured to store one or more items 22 of merchandise, where each item of merchandise may have a radio frequency identification (RFID) tag 24 to identify the respective item of merchandise. Each display cabinet may further comprise a door 12B, 32 configured to move between an opened position and a closed position, the opened position allowing the one or more items of merchandise to be placed into or removed from the monitored space. Each display cabinet may further comprise a trigger device 74 configured to provide a trigger signal to indicate when the respective door has moved from the opened position to the closed position. Also, each display cabinet may further comprise an RFID reader 78 configured, in response to the trigger signal, to detect the presence of the one or more items of merchandise within the monitored space of the respective display cabinet. Each display cabinet may further comprise a communication device 76 configured to send inventory information to the backend device 66, the inventory information including times and/or dates when the respective door was opened or closed, and/or the one or more items of merchandise contained with the respective display cabinet when the respective trigger signal indicates that the respective door has moved from the opened position to the closed position.

In addition, the inventory tracking system may further be configured such that each display cabinet further comprises an electronic lock configured to be unlocked with an electronic key associated with a specific person. The inventory information further comprises information regarding times and/or dates when the specific person unlocks/locks the electronic lock and/or opens/closes the door. The trigger device of each respective display cabinet may be incorporated in the electronic lock of each respective display cabinet. The electronic key may be configured to record times and/or dates when the electronic lock was unlocked and locked, times and/or dates when the door was opened and closed, and items of merchandise that the RFID reader identified as being present within the monitored space, and wherein the communication device is incorporated with the electronic key.

The foregoing has described one or more exemplary embodiments of a merchandise display security system. Embodiments of a merchandise display security system have been shown and described herein for purposes of illustrating and enabling one of ordinary skill in the art to make, use and practice the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

1. An inventory tracking device comprising:
a secure enclosure having a monitored space defined by a fixed portion and a movable portion, the secure enclosure configured to store one or more items of merchandise in the monitored space, each item of merchandise having a radio frequency identification (RFID) tag to identify the respective item of merchandise, wherein the movable portion is configured to move between an opened position and a closed position, the opened position allowing items of merchandise to be placed into or removed from the monitored space; and
an RFID reader configured, in response to the movable portion being moved to the opened position or the closed position, to detect the presence of the one or more items of merchandise within the monitored space of the secure enclosure.

2. The inventory tracking device of claim 1, wherein the moveable portion is a door or a sliding drawer and the fixed portion is a cabinet.

3. The inventory tracking device of claim 1, further comprising an electronic lock configured to lock the movable portion to the fixed portion and to be unlocked with an electronic key.

4. The inventory tracking device of claim 3, further comprising a processor configured to detect when the electronic lock is unlocked and/or locked or the movable portion is opened and/or closed.

5. The inventory tracking device of claim 4, further comprising a power source configured to power the processor and the electronic lock.

6. The inventory tracking device of claim 5, wherein the power source includes one or more batteries.

7. The inventory tracking device of claim 3, wherein the electronic key is associated with an authorized person.

8. The inventory tracking device of claim 1, further comprising a trigger device configured to provide a trigger signal to indicate when the moveable portion has moved from the opened position to the closed position.

9. The inventory tracking device of claim 8, wherein the trigger device is incorporated in an electronic lock configured to be unlocked with an electronic key.

10. The inventory tracking device of claim 9, wherein the electronic key is configured to record a time and/or date when the electronic lock was unlocked and locked, a time and/or date when the moveable portion was opened and closed, and/or items of merchandise that the RFID reader identified as being present within the monitored space.

11. The inventory tracking device of claim 9, further comprising a communication device configured to communicate inventory information, the inventory information including at least identifying information of the electronic key, times and/or dates when the electronic lock was unlocked or locked, times and/or dates when the moveable portion was opened or closed, and/or the one or more items of merchandise contained with the secure enclosure when the trigger signal indicates that the moveable portion has moved from the opened position to the closed position.

12. The inventory tracking device of claim 11, wherein the communication device is a wireless transmitter configured to wirelessly transmit inventory information by cellular or Wi-Fi signals to a back-end device via a network.

13. The inventory tracking device of claim 8, wherein the trigger device includes an electrical or electromechanical switch configured to detect when the moveable portion is in the closed position or opened position.

14. The inventory tracking device of claim 13, wherein the electrical or electromechanical switch includes a magnetic switch.

15. The inventory tracking device of claim 8, wherein the RFID reader is configured to wait for a predetermined amount of time after receiving the trigger signal before detecting the presence of the one or more items of merchandise within the monitored space of the cabinet.

16. The inventory tracking device of claim 8, further comprising a plurality of RFID readers operating in unison, the plurality of RFID readers configured, in response to the trigger signal, to detect the presence of the one or more items of merchandise within the monitored space of the secure enclosure.

17. A method of tracking inventory comprising:
determining when a moveable portion of a secure enclosure has been opened;
determining when the moveable portion has been closed; and
when it is determined that the moveable portion has been opened or closed, utilizing a radio frequency identification (RFID) reader to perform an RFID scan of one or more items of merchandise within the secure enclosure to determine inventory information.

18. The method of claim 17, further comprising determining the identity of a user who opened or closed the moveable portion.

19. The method of claim 17, further comprising recording times and/or dates when the moveable portion was opened and when it was closed.

20. The method of claim 17, further comprising the step of communicating the inventory information to a remote backend device.

21. An inventory tracking system comprising:
a backend device; and
a plurality of secure enclosures;
wherein each secure enclosure comprises a monitored space configured to store one or more items of merchandise, each item of merchandise having a radio frequency identification (RFID) tag to identify the respective item of merchandise;
wherein each secure enclosure further comprises a moveable portion configured to move between an opened position and a closed position, the opened position allowing the one or more items of merchandise to be placed into or removed from the monitored space;
wherein each secure enclosure further comprises a trigger device configured to provide a trigger signal to indicate when the respective moveable portion has moved from the opened position to the closed position; and
wherein each secure enclosure further comprises an RFID reader configured, in response to the trigger signal, to detect the presence of the one or more items of merchandise within the monitored space of the respective secure enclosure; and
wherein each secure enclosure further comprises a communication device configured to send inventory information to the backend device.

22-26. (canceled)

27. An inventory tracking device comprising:
a secure enclosure having a monitored space defined by a fixed portion and a movable portion, the secure enclosure configured to store one or more items of merchandise in the monitored space, each item of merchandise having a radio frequency identification (RFID) tag to identify the respective item of merchandise, wherein the movable portion is configured to move between an opened position and a closed position, the opened position allowing items of merchandise to be placed into or removed from the monitored space;
an electronic lock configured to lock the movable portion to the fixed portion and to be unlocked with an electronic key; and
an RFID reader configured, in response to the electronic lock being unlocked or locked, to detect the presence of the one or more items of merchandise within the monitored space of the secure enclosure.

28. (canceled)
